(19) United States
(12) Patent Application Publication
(10) Pub. No.: US 2017/0123625 A1
(43) Pub. Date: May 4, 2017

(54) METHOD, DEVICE, APPARATUS AND COMPUTER-READABLE MEDIUM FOR APPLICATION SWITCHING

(71) Applicant: Xiaomi Inc., Beijing (CN)

(72) Inventors: Yi Gao, Beijing (CN); Hongqiang Wang, Beijing (CN); Yunyuan Ge, Beijing (CN)

(73) Assignee: Xiaomi Inc., Beijing (CN)

(21) Appl. No.: 15/150,133

(22) Filed: May 9, 2016

(30) Foreign Application Priority Data
Oct. 30, 2015 (CN) 201510729110.6

(51) Int. Cl. G06F 3/0488; G06F 3/0481; G06F 3/041

(52) U.S. Cl. CPC G06F 3/0488; G06F 3/0412; G06F 3/0481

(57) ABSTRACT

Methods, devices, and computer-readable medium are disclosed for application switching between background and foreground on the display interface of a terminal device. In one embodiment, a method includes: maintaining a correspondence relationship between each of one or more opened background applications and each of one or more predetermined touch operations on a rear touch screen of a terminal, detecting a user touch operation on the rear touch screen, switching to background a foreground application on a current display interface of a front display screen of the terminal, and switching to foreground an application selected from the one or more opened background applications based on the correspondence relationship and the detected user touch operation.

### CROSS-REFERENCE TO RELATED APPLICATION

This application claims priority to Chinese Patent Application No. 201510729110.6, filed on Oct. 30, 2015, which is incorporated herein by reference in its entirety.

### FIELD

The present disclosure generally relates to a technical field of mobile communication, and more particularly to methods, devices, apparatus and computer-readable medium for application switching into and from a foreground or background of a display interface.

### BACKGROUND

A smart device such as a mobile terminal may provide a user with a variety of applications (“apps”). The user may run any installed application on the mobile terminal. The mobile terminal may provide the user with an operating environment in which multiple applications may simultaneously run on the mobile terminal. Because the size of the display screen of the mobile terminal may be limited, only one or a subset of apps may be actively operated and viewed in the foreground on the display screen by the user. The rest of the apps may be running in the background. The user may desire to switch an application from the background to the foreground quickly. For example, the user may be currently viewing and operating a “short message service (SMS)” interface of a SMS app in the foreground and he/she may desire to quickly switch to a browser interface of a browser app running in the background.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a method for application switching between foreground and background is disclosed. The method comprises detecting a user touch operation on a rear touch screen of a terminal, switching to background a foreground application on a current display interface of a front display screen of the terminal, and switching to foreground an application selected from one or more opened background applications based on the detected user touch operation and a correspondence relationship between each of the one or more opened background applications and each of one or more predetermined touch operations on the touch screen of a terminal, wherein the touch screen is located separately from the front display screen on the terminal.

In another embodiment, a device for application switching is disclosed. The device comprises a processor, a memory for storing instructions executable by the processor, a front display screen, and a touch screen located separate from the front display screen, wherein the processor is configured to detect a user touch operation on the touch screen, switch to background a foreground application on a current display interface of the front display screen of the terminal, and switch to foreground an application selected from one or more opened background applications running on the device based on the detected user touch operation and a correspondence relationship between each of the one or more opened background applications and each of one or more predetermined touch operations on the touch screen.

In yet another embodiment, a non-transitory computer-readable storage medium having instructions stored therein is disclosed. The instructions when executed by a processor of a terminal cause the terminal to detect a user touch operation on a touch screen of the terminal, switch to background a foreground application on a current display interface of a front display screen of the terminal, and switch to foreground an application selected from one or more opened background applications running on the terminal based on the detected user touch operation and a correspondence relationship between each of the one or more opened background applications and each of one or more predetermined touch operations on the touch screen of the terminal, wherein the touch screen is located separately on the terminal from the front display screen.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 illustrates a terminal device.

FIG. 2 is a flow chart illustrating a method for application switching according to an exemplary embodiment.

FIG. 3 is a flow chart illustrating another method for application switching according to an exemplary embodiment.

FIG. 4 is a flow chart illustrating yet another method for application switching according to an exemplary embodiment.

FIG. 5 is a block diagram illustrating a device for application switching according to an exemplary embodiment.

FIG. 6 is a block diagram illustrating another device for application switching according to an exemplary embodiment.

FIG. 7 is a block diagram illustrating a terminal device according to an exemplary embodiment.

FIG. 8 is a block diagram illustrating another device according to an exemplary embodiment.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the invention. Instead, they are merely examples of devices and methods consistent with aspects related to the invention as recited in the appended claims.

Terms used in the disclosure are only for purpose of describing particular embodiments, and are not intended to be limiting. The terms “a”, “said” and “the” used in singular form in the disclosure and appended claims are intended to include a plural form, unless the context explicitly indicates otherwise. It should be understood that the term “and/or” used in the description means and includes any or all combinations of one or more associated and listed terms.

It should be understood that, although the disclosure may use terms such as “first”, “second” and “third” to describe various information, the information should not be limited herein. These terms are only used to distinguish information of the same type from each other. For example, first information may also be referred to as second information, and the second information may also be referred to as the first information, without departing from the scope of the disclosure. Based on context, the word “if” used herein may be interpreted as “when”, or “while”, or “in response to a determination”. The term “terminal” may be referred to as terminal device, mobile terminal, mobile device, or any other type of user device. The term “touch operation” and “touch action” on a touch screen are used interchangeably.

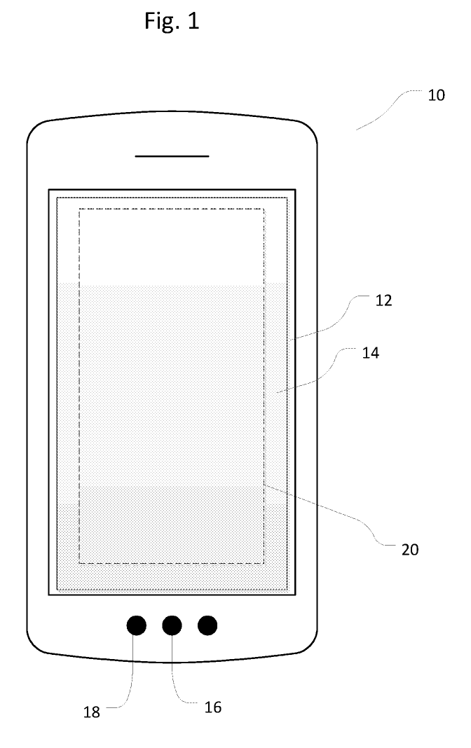

By way of introduction, a smart device such as a mobile phone illustrated by 10 in FIG. 1 may be installed with an operating system, such as Google Android and Apple OS X. The smart device 10 may comprise a front display screen 12, a front touch screen 14, a home button 16, a return button 18, and a second touch screen 20. The front display screen may be but is not limited to a LCD panel. The front display screen 12 may be integrated with a front touch screen 14 as an input interface. Alternatively, the front touch screen 14 may be of substantially the same size as the front display screen 12 and placed on top of the front touch screen 12. The touch screen may alternatively be referred to as touch panel. Applications, or apps, may be installed and run within the operating environment of the smart device. The operating system of the smart device may allow multiple apps to be run at the same time. However, the size of the front display screen 12 may be limited and thus only one (or a subset) of the app interfaces may be displayed on the front display screen at any given time and the user may only be able to interact with this one app via the front touch screen 14. This app interface occupies the front display screen and is visible to the user. It is thus in the foreground. The user may not interact with the other apps that are simultaneously running in the background. To switch an app from the background into the foreground to replace the app currently in the foreground, the user may instruct the terminal to switch using the front touch screen 14 or other buttons on the smart device, such as home button 16, or return button 18. The home button, for example, may switch the app currently in the foreground into the background, and display the home interface of the operating system. From there, the user may access other open or unopen apps via icons shown for those applications on the home interface of the operating system on the front display screen. The return button, as another example, may switch the app currently in the foreground into the background, and display the last shown interface of the operating system (rather than the home interface), e.g., content of an app folder under the operating system. From there, the user may access other applications and switch one of them into the foreground from the background.

The embodiments below provide a second touch screen 20 which may be used to conveniently sense a touch by the finger of the hand of the user holding the smart device. As an example, the second touch screen 20 illustrated in FIG. 1 is placed on the rear surface of the smart device. It may be placed anywhere on the smart device that is convenient for the holding fingers to make touch actions. It may be a separate touch screen from the front display screen. The sensed touch action on the second touch screen 20 may be classified and analyzed to instruct the smart device to quickly switch an app in the background into the foreground (and thus simultaneously switch the app currently in the foreground into the background). Each specific touch action on the second touch screen may correspond to a particular application being switch into the foreground.

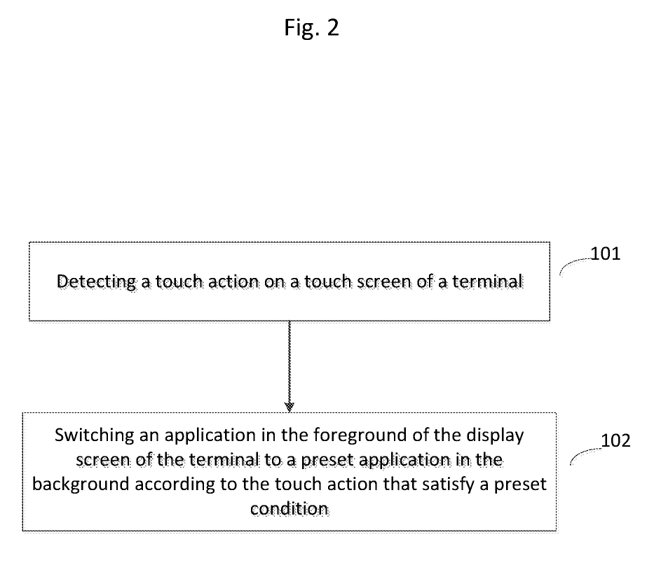

FIG. 2 is a flow chart illustrating a method for application switching according to an exemplary embodiment. The method may be applied in a terminal having a front touch screen and a second touch screen implemented as a rear touch screen placed on the face of the terminal opposite to the front screen. At least the front touch screen may be integrated with a display screen of the terminal, such as a LCD screen. The term “rear” may be referred to as “back”.

In step 101, a touch operation on the rear screen of the terminal may be detected. For example, a system application communicating with touch sensors on the rear touch screen may be used to monitor a touch operation of a user on the rear screen of the terminal. The touch operation may be, for example, various sliding/swiping operations or clicking operations. The term sliding and swiping refer to touch actions of a finger (or stylus) moving across a distance while maintaining contact with the touch screen. The two terms are used interchangeably. The system application may be a component of the operating system running on the terminal or may be some other dedicated application running on the terminal. The term “touch operation” may also be referred to as “touch action” and the two terms are interchangeable.

In step 102, an application running in the foreground or the current interface of the front display screen of the terminal may be switched to a preset application running in the background in response to the detected user touch operation on the rear touch screen. The system application for monitoring the touch operation or some other component of the operating system may keep a mapping or correspondence between a list of specific touch actions on the rear touch screen and a list of applications to be switched into the foreground. Alternatively, the terminal may maintain a rule implemented in software or hardware that switch in background applications of certain type or timing based on the touch operation, as will be detailed below. For example, a specific application or an application of a specific type or timing to be switched into the foreground from the background may be determined by a sliding direction or sliding distance of the touch operation. The sliding distance, i.e., the contact length of a user finger with the rear touch screen while making a sliding action may further be used as a threshold for switching. Specifically, a switching of the application from the background to the foreground may be conditioned on the sliding distance being larger than or equal to a predefined threshold or minimum value.

For example, an application opened immediately before the application currently in the foreground or on the current display interface of the front screen may be switched into the foreground when the touch action is a left sliding action. Such a switching may alternatively be set to occur when the touch action is a left sliding action and the sliding distance is larger than or equal to the predefined threshold value. In another example, the application opened the earliest may be switched into the foreground in response to some other touch action, e.g., either the touch action is a right sliding action or the touch action is a right sliding action with a sliding distance larger than or equal to the predefined threshold value. Alternatively, the above correspondence between the touch action and applications to be switched into the foreground may be reversed, i.e., a left sliding action may correspond to switching to the application opened the earliest and the right sliding action may correspond to the application opened immediately before the application currently in the foreground. The abovementioned sliding direction and the sliding distance may be determined according to a start position and an end position of the touch operation on the rear screen of the terminal detected by the touch sensors in the rear touch screen.

Thus, in the embodiment of FIG. 2, a correspondence is preset between touch operations (such as sliding or clicking operations) on a rear screen of a mobile terminal having both a front display screen and the rear touch screen and applications to be switched from the background to the foreground. Switching of an application in the background into the foreground to replace the application currently in the foreground or the current display interface of the front screen of the terminal is based on a detected touch operation on the rear screen of the terminal and the correspondence relationship above. In such a way, quick switching of application desired by the user into the foreground is achieved through a touch operation on the real touch screen of the terminal, providing improved user experience and convenience.

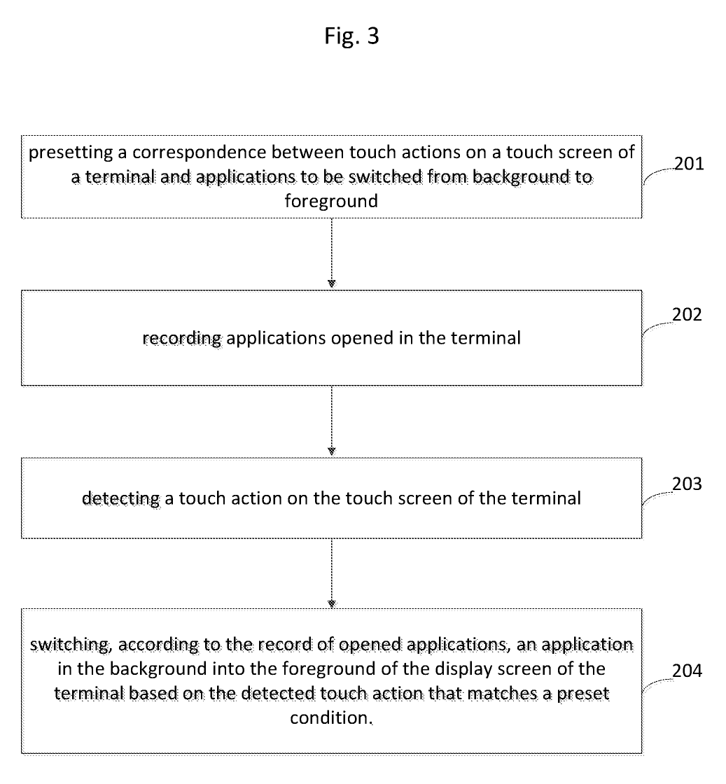

FIG. 3 is a flow chart illustrating another method for application switching according to an exemplary embodiment. As compared with the flow chart of FIG. 2, in the flow chart of FIG. 3, the application switching may be performed according to a record or log of opened applications. For example, the log may keep the opened applications in the background in a time order such that a particular touch action on the rear touch screen may correspond to an application to be switched to the foreground having a particular time position in the log. For example, a touch action may correspond to an application that is opened by the user the earliest and the log, in keeping track of some timing order, may help determine which application in the background was opened the earliest.

In step 201, a correspondence between a set of predefined touch operations on the rear screen of the terminal and applications to be switched to the foreground may be preset. Each touch action in the set of predefine touch actions is determined by analyzing one or more of a set of parameters or touch signal obtained from the rear touch sensors, such as touch/click position, touch distance, touch time period, speed of swipe, and direction of swipe. For each touch action in the set of predefined touch actions, correspondence relation such as that discussed above determines an application among the applications in the background to be switched to the foreground.

Sliding/swiping direction and distance may be used to analyze and define some touch actions for switching. For example, a left sliding/swiping or a left sliding/swiping with distance larger or equal to a pre-defined threshold value may correspond to switching to the foreground an application opened immediately before the current foreground application. A right sliding/swiping or right sliding/swiping with distance larger or equal to a pre-defined distance threshold value may correspond to switching to the foreground the application in the background that is opened the earliest. Alternatively, the above configuration may be reversed.

Other parameters, such as touch/click position and time duration of the touch action on the rear touch screen may be used for determining the switching of the applications from the background to the foreground. For example, a touch/click on the left side of the rear touch screen or touch/click on the left side of rear screen with a duration larger than or equal to a predefined time threshold value may correspond to switching to the foreground the application opened immediately before the current foreground application on the current display interface of the front screen. For another example, a touch/click on the right side of the rear touch screen or touch/click on the right side of rear touch screen with a duration larger than or equal to the predefined time threshold value may correspond to switching to the foreground the background application opened the earliest. Alternatively, the above configuration may be reversed.

Those of ordinary skill in the art understand that the above correspondence between touch actions and switching of applications to the foreground are only examples. A combination of the touch parameters discussed above and other touch parameters may be used to define the set of touch actions in the correspondence relationship for switching. Other example of preset touch actions may be: sliding up, sliding down, sliding up with distance larger than 2 cm, double click on the upper right corner, touch on the right side longer than 2 second, fast swiping to the left, circular swiping anywhere, or any other predefined touch actions.

In step 202, applications opened through touch operations on the front screen of the terminal may be recorded or logged. The term “record” and “log” are used interchangeably. The log of opened applications may include names and receding time information of the opened applications. The name of an application recorded may be replaced with any other form of application ID that uniquely identifies the application. The receding time of an open and running application represents the time when the application recedes to another application and goes to the background. For the recorded opened applications, time of each of the opened applications receding for the first time to another application since being started may be recorded. In one implementation, the receding time of the opened application would not be updated even if the opened application subsequently goes in and out of the background once again. In such a way, the record or log of opened applications may be ordered according to the receding time of each of the opened applications receding for the first time.

In step 203, a touch operation on the rear screen of the terminal may be detected. For example, the operating system or other system applications or even hardware components may be used to monitor a touch operation of a user on the rear screen of the terminal. The touch operation, for example, may be various sliding or clicking operations.

In step 204, the foreground application on the current interface of the front screen of the terminal may be switched into the background, replaced by one of the opened applications in the record or log, according to the detected touch action and the correspondence relationship discussed for step 201. For example, the correspondence relationship discussed above may be based on the receding time of the running applications. In other words, a particular touch action may correspond to switching to the foreground an application of a particular receding time in the record or log. Thus, the preset application among the open applications to be switched into the foreground corresponding to the touch operation may be determined with reference to the receding time information of the opened applications recorded or logged in step 202.

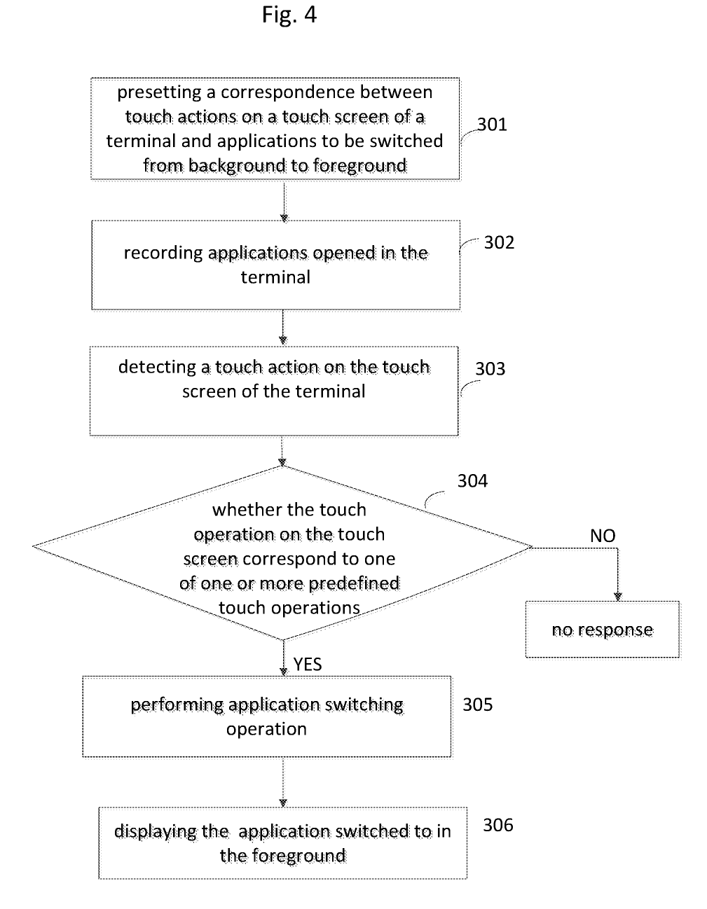

FIG. 4 is a flow chart illustrating another method for application switching according to an exemplary embodiment. This method may be used in a terminal. Again, the terminal may be equipped with a front touch screen and a rear touch screen. At least the front touch screen may also be integrated with a front display screen, such as an LCD screen. The rear touch screen may receive touch operations of a user on the rear screen. The terminal may analyze various detected touch parameters such as sliding direction, sliding distance, sliding speed, touch position, and time length of touch. The terminal in turn control which application will be switched to the foreground and be display on the front display screen according to a preset correspondence between touch actions on the rear screen and applications.

In step 301, a correspondence between touch operations on the rear screen of the terminal and applications to be switched may be preset. For example, the following may be set as part of the correspondence relation. Sliding towards left may correspond to switching a preceding application opened right before the current foreground application to the foreground. Sliding towards right may correspond to switching the earliest-opened application to the foreground. Alternatively, sliding towards right may correspond to switching a preceding application opened right before the current foreground application to the foreground and sliding towards left may correspond to switching the earliest-opened application to the foreground. The configuration of touch action corresponding to the switching may be set in many other ways, such as those discussed for step 201 of FIG. 3.

For example, sliding in an up-down direction may also be included in addition to the sliding in the left-right direction in setting the correspondence. For example, if the user's finger slides upward, the terminal may invoke switching to a preceding application opened right before the current foreground application. If the user's finger slides downward, the terminal may invoke switching to an earliest-opened application. Alternatively, sliding downwards may correspond to switching a preceding application opened right before the current foreground application to the foreground and sliding upwards may correspond to switching the earliest-opened application to the foreground.

The above example only illustrates examples and part of the correspondence involving direction of sliding or swiping touch operation. However, other touch parameters for the sliding or swiping action may be used. In addition, the touch operation may be of other type such as a click operation. For example, left side click may correspond to switching the foreground to the preceding application opened right before the current foreground application and a right side click may correspond to switching to the earliest opened application. Alternatively, right side click may correspond to switching the foreground to the preceding application opened right before the current foreground application and a left side click may correspond to switching to the earliest opened application. Alternatively, click operations on an upper part or lower part of the rear touch screen may be set to correspond to switching an application to the foreground in similar ways.

Furthermore, in order to reduce false touch operation recognition on the rear screen and prevent unintended application switching, a threshold value for some touch parameters may be set. For example, a threshold, or a minimum value may be set for sliding distance of slide or swiping actions. A distance value of 3 cm, for example, may be defined as the distance threshold. With this threshold, application switching corresponding to a sliding or swiping action will only be activated when the sliding distance of the action on the rear screen is larger than or equal to the threshold of 3 cm. For example, if the user's finger slides towards the left and the sliding distance is larger than or equal to the threshold value of sliding distance, e.g., 3 cm, switching to foreground the preceding application opened right before the current foreground application may be activated. As another example, if the user's finger slides towards the right and the sliding distance is larger than or equal to the threshold value of sliding distance, switching the earliest opened application to the foreground may be activated. However, in either of the above two examples, if the sliding distance is smaller than the threshold, no switching action may be activated.

In a similar manner, activation of the switching of applications to the foreground may be conditioned on time duration of the touch action on the rear touch screen. A time duration threshold may be similarly set. Switching may be activated when a touch duration exceeds the threshold value. For example, the time duration threshold may be set at 3 seconds. As part of the correspondence between touch actions and switching, a touch on the on the left side of the rear touch screen for longer than or equal to 3 seconds may correspond to switching to the foreground the preceding application opened right before the current foreground application. Similarly, a touch on the right side of the rear touch screen with a touch duration larger than or equal to 3 second may correspond to switching to the foreground the application opened the earliest.

In step 302, information related to applications opened by the user on the front display screen may be recorded or logged. When the user uses the mobile terminal in normal courses, an application active in the foreground will recede in some situations to the background, for example: (1) the system may in some situation send the application to the background or exit the application upon detection of a user's click on a “Return” button; or (2) the system may set the application as a background application upon detection of a user's click on the “Home” button.

For either of the above two situations, the system may record the application's name and receding time, and record the application in a log of opened applications. The name of an application recorded may be replaced with any other form of application ID that uniquely identifies the application. The log may be in an exemplary form as shown in Table 1.

TABLE 1

| Names of applications | Receding time |
|---|---|
| Camera | 2015-07-07 06:57 |
| Browser | 2015-07-07 7:00 |
| Short Message Service (SMS) | 2015-07-07 7:05 |
| Microblog | 2015-07-07 7:07 |
| . . . | . . . |

As shown in the example log, the camera application recedes at 06:57, so it is the first receded application. Because opening another application may involve moving the camera application to the background, the camera application is also the first opened application. Further, the microblog application recedes at 7:07, so it is the last receded application and the application right before the current foreground application.

In one implementation, an application may be recorded in the list of “opened applications” when it recedes for the first time. That is, the list may be updated by adding a new record to record receding time of a recently receded application. However, the receding time in the list would not be updated even if the application goes in and out of the foreground once again, such that all the applications may be ordered according to the receding time of each of the applications receding for the first time. The recording of the receding time that an application recedes to the background or exit for the first time is just an example. Other receding times, for example, the most recent time that the application receded to the background may be recorded.

In step 303, a touch operation on the rear touch screen of the terminal may be detected and identified. The touch sensor may detect various touch signals and determine the type of touch action (or touch gesture) and parameters associated with it. Touch signals may include but are not limited to current intensity flowing through the touch sensor grid. The parameters associates with the touch action may be the positions of the touch and the time duration of the touch. Taking a sliding touch operation as an example, the terminal may acquire via the touch sensor circuitry a start position and an end position of a sliding action on the rear touch screen in a transverse axis direction of the rear touch screen denoted as the X axis. The start and end position in the X direction may be x1 and x2, respectively. The direction of the user slides along the X axis may be determined. For example: (1) if x1−x2<0: the sliding is towards left; and (2) if x1−x2>0: the sliding is towards right. The direction denoted as left or right above is only relative and used to denote two opposite directions along the X axis. The terminal may define left and right in an opposite way. Similarly, the terminal may acquire via the touch sensor circuitry a start position and end position of a sliding action on the rear screen in a longitudinal axis direction denoted as Y. The start and end position in Y direction may be y1 and y2. Similarly, relative direction of upwards or downwards may be determined by comparing y1 and y2 in a way similar to the determination of relative slide direction in the X axis. The transverse and longitudinal directions are relative and may be defined by the touch sensor circuitry in any suitable manner.

A sliding distance may also be calculated according to the start position and the end position. The sliding distance is a distance of a sliding gesture staring from a position where the user's finger touches the screen to another position where the user's finger stops sliding and moves away from the screen. If the threshold is set for sliding distance, as discussed previously, activation of a switching to the foreground a corresponding application may be condition on the sliding distance of a sliding action being larger than or equal to the threshold.

The terminal may acquire time duration of a touch action between the time that the user finger begins to touch the screen and the time that the user completes the touch action and moves away from the screen.

In step 304, it is determined whether the touch operation on the rear screen satisfies a preset condition such as the touch distance threshold discussed above. If the conditions satisfied, the method may proceed to step 305. Otherwise, no switching would be performed. For example, the sliding direction and sliding distance of the touch operation of the user on the rear screen as determined in step 303 may be used to check whether the touch sliding distance is larger than or equal to the threshold. If it is smaller than the threshold value of sliding distance, no switching would be performed, and if the sliding distance is larger than or equal to the preset threshold value, step 305 would be performed.

Alternatively, the preset condition may be based on the touch time duration being larger than or equal to a preset time duration threshold. If the click duration is smaller than the time threshold value, no process would be performed; and if the click duration is larger than or equal to the time threshold value, step 305 would be performed.

In step 305, the application switching operation may be performed. As discussed above, a left sliding may be preset to correspond to switching to the foreground the preceding application opened right before the current application in the foreground. Further, a right sliding may correspond to switching to the foreground the earliest-opened application, i.e., the firstly opened application. Therefore, with the correspondence above, when the touch operation is determined as a sliding towards left, an application having a receding time earlier than and closest to the current time (i.e., the application opened right before the current application in the foreground) may be identified from the log of “opened applications” recorded in step 302. When the touch operation is determined as sliding towards right, an application whose receding time is the earliest in the log(i.e., the firstly receded application) may be identified from the log of “opened applications”.

As an example for step 305, referencing Table 1 and assuming that the current time is 7:15 and the application currently active on the front display screen is a “game” app, the “microblog” app will be opened and switched to the foreground on the front display screen upon detection of, for example, a sliding operation towards left and with a sliding distance larger than or equal to the threshold vale of sliding distance, since the “microblog” app has a receding time of 7:07 which is earlier than the current time 7:15 and the “microblog” app is the application among the applications in the log of Table 1 with the latest receding time, i.e., the “microblog” app is the application opened right before the “game” application. The “camera” app may be switched to the foreground upon detection of a sliding operation towards right and with a sliding distance larger than or equivalent to the threshold vale of sliding distance, since the “camera” app has a earliest receding time among the applications logged in Table 1, i.e., the “camera” app is the first opened application. The above examples consider the preset threshold in sliding distance as a condition for switching. In some other implementation, the switching may also be implemented based on the sliding direction without the condition regarding the threshold value of sliding distance.

In step 306, the application being switched to the foreground may be actively shown on the front display screen and being regarded as the current foreground application.

Further touch actions on the rear touch screen will be treated in similar ways. For example, in case that the user's finger slides towards left on the rear touch screen once again, the previous application switched into the foreground may be taken as the current application and the application opened right before it would be switched into the foreground. Specifically continuing on the example above, in case that the user's finger slides towards left once again after the microblog application has been switched into the foreground, the SMS application receded right before the microblog application would be switched into the foreground.

Thus, in the embodiment of FIG. 4, quick application switching via a touch operation on the rear screen can be achieved and user experience is enhanced by presetting a correspondence between opened background applications and touch operations on the rear touch screen, logging information (including names and receding time) related to the opened applications, detecting a touch operation on the rear screen, and switching into the foreground a corresponding application from the opened applications in the log according to the touch action and optionally conditioned on some touch parameters such as sliding distance and time duration of the touch operation meeting certain thresholds or being within a certain range.

Further embodiments of a device for application switching corresponding to the above embodiments of methods may be provided and are illustrated below.

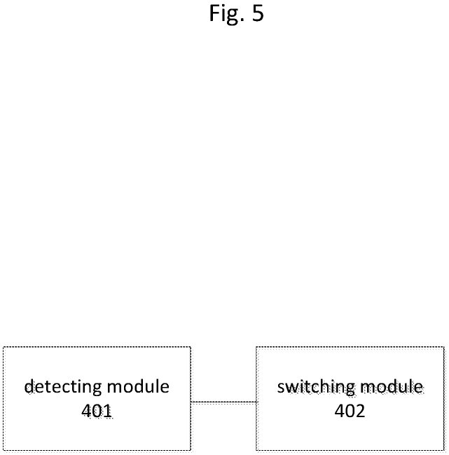

FIG. 5 is a block diagram illustrating a device for application switching according to an exemplary embodiment. The device may include a detecting module 401 and a switching module 402. The detecting module 401 may be configured to detect a touch operation on a rear touch screen of a terminal. The switching module 402 may be configured to switch an background application into the foreground and display that application on the front display screen of the terminal according to a preset correspondence between touch actions and applications to be switches.

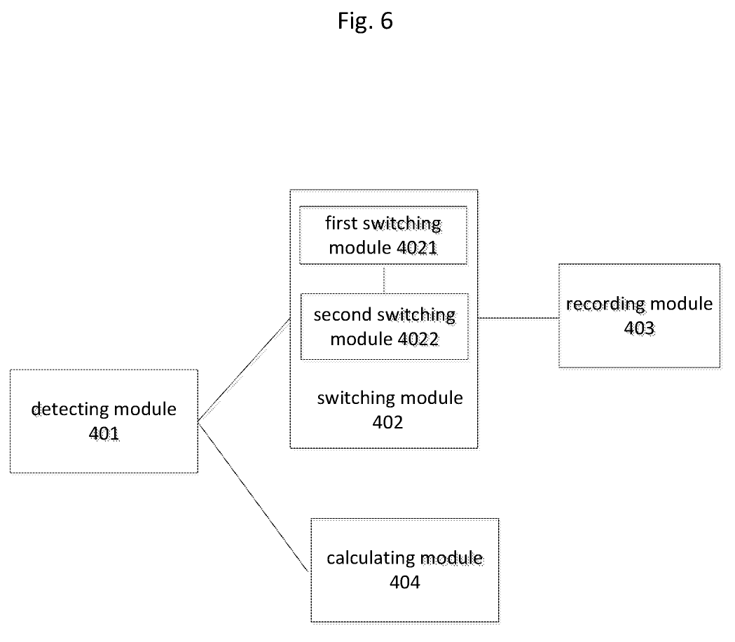

FIG. 6 is a block diagram illustrating another device for application switching according to an exemplary embodiment. The device of FIG. 6 may include a detecting module 401, a switching module 402, a recording module 403, and calculating module 404. The functionality of the detecting module 401 and switching module 402 is similar to that of FIG. 5 and the corresponding description above for FIG. 5 applies. The recording module 403 may be configured to establish and maintain a record or log of opened applications. The switching module 402 may be configured to switch, according to the log of opened applications recorded by the recording module 403, the application currently in the foreground and on the front display screen of the terminal into the background and to switch one of the applications in the log corresponding to the touch operation into the current foreground, optionally conditioned on the touch operation matching some preset conditions (such as thresholds of sliding distance, or time duration of the touch operation).

The log of opened applications recorded by the recording module 403 may include names and receding time information of the opened applications. The correspondence between touch actions on the rear touch screen and opened applications to be switched into the foreground may be partially determined by the receding time information for the opened applications. The opened applications recorded by the recording module 403 may be ordered according to receding time of each of the opened applications.

In one embodiment, the switching module 402 may comprise a first switching module 4021 or alternatively a second switching module 4022. The first switching module 4021 may be configured to switch the application on the current display interface of the front screen of the terminal into background and to switch to the foreground the preset application corresponding to the touch operation based on a sliding touch operation with sliding direction matching a preset direction for switching. Alternatively, the second switching module 4022 may be configured to switch the application on the current display interface of the front screen of the terminal into the background and to switch to the foreground the preset application corresponding to the touch operation based on a sliding touch operation with matching direction and a sliding distance larger than or equal to a predefined threshold value. For example, an application opened right before the application on the current display interface of the front screen may be switched into the foreground when the sliding direction of the touch operation is towards left or when the sliding direction of the touch operation is towards left and the sliding distance is larger than or equal to the pre-defined threshold value. The application opened the earliest may be switched in the foreground when the sliding direction of the touch operation is towards right or when the sliding direction of the touch operation is towards right and the sliding distance is larger than or equal to the predefined threshold value.

In another implementation, the first switching module 4021 may be configured to switch the application on the current display interface of the front screen of the terminal into the background and to switch into the foreground the application corresponding to the touch operation having a particular touch position on the rear touch screen. Alternatively, the second switching module 4022 may be configured to switch the application on the current display interface of the front screen of the terminal into the background and to switch into the foreground the application corresponding to the touch operation having a particular touch position on the rear touch screen and a touch time duration larger than or equal to a predefined threshold value.

The calculating module 404 may be configured to determine the sliding direction and the sliding distance according to a start position and an end position of the touch operation on the rear screen of the terminal.

Thus, in the embodiment of FIG. 6, by presetting a correspondence between touch operations (such as slide or click operations etc.) on the rear screen of the terminal and applications to be switched and recording in a log information about applications opened on the front screen by the user (including names and receding time of the applications), the application in the current display interface on the front screen of the terminal may be switched into the background and an application in the log corresponding the touch operation may be switched into the foreground optionally conditioned on the touch action parameters satisfying some preset condition.

As to the processes for implementing functions of each of the components in the devices of FIG. 5-5, the description of corresponding steps in the method embodiments of FIG. 2-3 applies. The device embodiments above are only examples, wherein the components described as discrete elements may be or may not be physically separated; the elements shown as components may be or may not be physical components, i.e., the elements may be located in one place or distributed to a plurality of networking components. A part or all of the modules may be selected to implement purposes of the solution of the disclosure as actually needed.

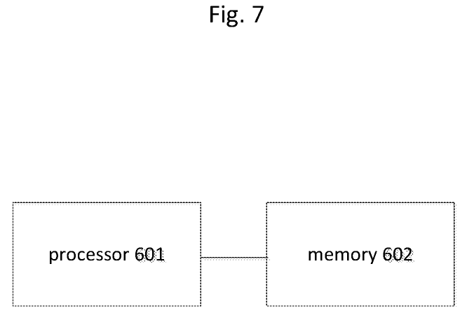

FIG. 7 is a block diagram illustrating a terminal device according to an exemplary embodiment. The terminal device may include a processor 601 and a memory 602 for storing instructions executable by the processor. The processor 601 is configured to: detect a touch operation on a rear screen of the terminal device; and switch an application on a current display interface of a front screen of the terminal device into the background and to switch a preset application corresponding to the touch operation to the foreground, optionally when the touch operation matches a preset condition. The processor 601 may be further configured to perform other executable instructions to implement corresponding steps in the above methods, which will not be elaborated herein.

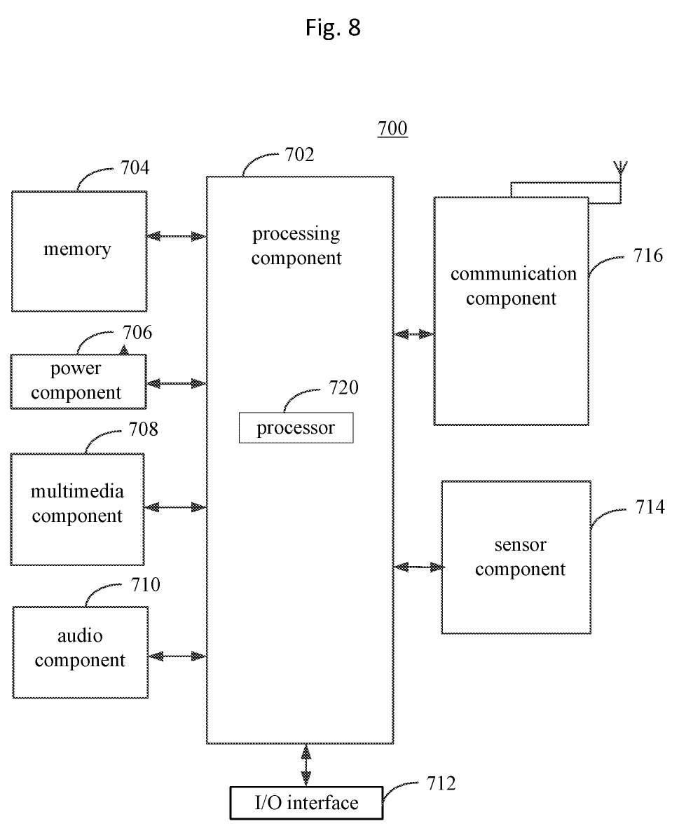

FIG. 8 is a structural block diagram illustrating a device according to an exemplary embodiment. For example, the device 700 may be a mobile phone, a computer, a digital broadcast terminal, a messaging device, a gaming console, a tablet, a medical device, exercise equipment, a personal digital assistant, and the like.

Referring to FIG. 8, the device 700 may include one or more of the following components: a processing component 702, a memory 704, a power component 706, a multimedia component 708, an audio component 710, an input/output (I/O) interface 712, a sensor component 714, and a communication component 716.

The processing component 702 may control overall operations of the device 700, such as the operations associated with display, telephone calls, data communications, camera operations, and recording operations. The processing component 702 may include one or more processors 720 to execute instructions to perform all or part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 may be configured to store various types of data to support the operation of the device 700. Examples of such data include instructions for any applications or methods operated on the device 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the device 700. The power component 706 may include a power management system, one or more power sources, and any other components associated with the generation, management, and distribution of power for the device 700.

The multimedia component 708 may include a display screen providing an output interface between the device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive an external multimedia data while the device 700 is in an operation mode, such as a photographing mode or a video mode. Each of the front camera and the rear camera may be a fixed optical lens system or have optical focusing and zooming capability.

The audio component 710 may be configured to output and/or input audio signals. For example, the audio component 710 may include a microphone (“MIC”) configured to receive an external audio signal when the device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, the peripheral interface modules being, for example, a keyboard, a click wheel, buttons, and the like. The buttons may include, but are not limited to, a home button, a volume button, a starting button, and a locking button.

The sensor component 714 includes one or more sensors to provide status assessments of various aspects of the device 700. For instance, the sensor component 714 may detect an open/closed status of the device 700, relative positioning of components (e.g., the display and the keypad, of the device 700), a change in position of the device 700 or a component of the device 700, a presence or absence of user contact with the device 700, an orientation or an acceleration/deceleration of the device 700, and a change in temperature of the device 700. The sensor component 714 may include a proximity sensor configured to detect the presence of a nearby object without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor or thermometer.

The communication component 716 may be configured to facilitate communication, wired or wirelessly, between the device 700 and other devices. The device 700 can access a wireless network based on a communication standard, such as WiFi, 2G, 3G, LTE, or 4G cellular technologies, or a combination thereof. In an exemplary embodiment, the communication component 716 receives a broadcast signal or broadcast associated information from an external broadcast management system via a broadcast channel. In an exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.\

In exemplary embodiments, there is also provided a non-transitory computer-readable storage medium including instructions, such as included in the memory 704, executable by the processor 720 in the device 700, for performing the above-described methods. For example, the non-transitory computer-readable storage medium may be a ROM, a RAM, a CD-ROM, a magnetic tape, a floppy disc, an optical data storage device, and the like.

Each module or unit discussed above for FIG. 5-6, such as the detecting module, the switching module, the first switching module, the second switching module, and the calculating module, may take the form of a packaged functional hardware unit designed for use with other components, a portion of a program code (e.g., software or firmware) executable by the processor 720 or the processing circuitry that usually performs a particular function of related functions, or a self-contained hardware or software component that interfaces with a larger system, for example.

The illustrations of the embodiments described herein are intended to provide a general understanding of the structure of the various embodiments. The illustrations are not intended to serve as a complete description of all of the elements and features of apparatus and systems that utilize the structures or methods described herein. Other embodiments of the disclosure will be apparent to those skilled in the art from consideration of the specification and practice of the embodiments disclosed herein. This application is intended to cover any variations, uses, or adaptations of the disclosure following the general principles thereof and including such departures from the present disclosure as come within known or customary practice in the art. It is intended that the specification and examples are considered as exemplary only, with a true scope and spirit of the invention being indicated by the following claims in addition to the disclosure.

It should be understood that the disclosure is not limited to the precise construction as described above and shown in the figures, but can have various modification and alternatives without departing from the scope of the disclosure. The scope of the disclosure is limited only by the appended claims.

What is claimed is:

1. A method for application switching between foreground and background, comprising:
detecting a user touch operation on a touch screen of a terminal;
switching to the background a foreground application on a current display interface of a front display screen of the terminal; and
switching to the foreground an application selected from one or more opened background applications running on the terminal based on the detected user touch operation and a correspondence relationship between each of the one or more opened background applications and each of one or more predetermined touch operations on the touch screen of the terminal,
wherein the touch screen is located separately from the front display screen on the terminal.

2. The method of claim 1, wherein the correspondence relationship between each of the one or more opened background applications and each of the one or more predetermined touch operations is based at least on an information log of the one or more opened background applications.

3. The method of claim 2,
wherein the information log of the one or more opened background applications comprises an application ID and receding time information for each of the one or more opened background applications;
wherein the receding time information of an background application comprises a time when the application was previously switched from the foreground to the background; and
wherein the correspondence relationship between each of the one or more opened background applications and each of the one or more predetermined touch operations is based at least on the receding time information in the log.

4. The method of claim 3,
wherein the one or more opened background applications as logged are ordered according to the receding time information; and
wherein the receding time information of an background application comprises a time when the application was switched from the foreground to the background for the first time since it was opened.

5. The method of claim 1, wherein the one or more predetermined touch operations comprise a swiping operation having a predefined swiping direction or having a predefined swiping direction and swiping distance larger than or equal to a predefined threshold distance value.

6. The method of claim 5, wherein the correspondence relationship comprising:
a first correspondence between a first background application opened right before the application currently active in the foreground and a touch operation of swiping towards one of a left or right direction or a touch operation of swiping towards one of the left or right direction with a swiping distance larger than or equal to the predefined threshold distance value; and
a second correspondence between a second background application opened the first among the one or more opened background applications and a touch operation of swiping towards the other of the left or right direction or a touch operation swiping towards the other of the left or right direction with a swiping distance larger than or equal to the defined threshold distance value.

7. The method of claim 5, wherein the swiping direction and the swiping distance are determined according to a start position and an end position of the touch operation on the rear touch screen of the terminal.

8. The method of claim 2, wherein the one or more predetermined touch operations comprise a swiping operation having a predefined swiping direction or having a predefined swiping direction and a swiping distance larger than or equal to a predefined threshold distance value.

9. The method of claim 3, wherein the one or more predetermined touch operations comprise a swiping operation having a predefined swiping direction or having a predefined swiping direction and a swiping distance larger than or equal to a predefined threshold distance value.

10. The method of claim 4, wherein the one or more predetermined touch operations comprise a swiping operation having a predefined swiping direction or having a predefined swiping direction and a swiping distance larger than or equal to a predefined threshold distance value.

11. The method of claim 1, wherein the one or more predetermined touch operations comprise a clicking operation having a predefined clicking position on the rear touch screen or having a predefined clicking position on the rear touch screen and a clicking time duration longer than or equal to a predefined threshold time duration value.

12. The method of claim 2, wherein the one or more predetermined touch operations comprise a clicking operation having a predefined clicking position on the rear touch screen or having a predefined clicking position on the rear touch screen and a clicking time duration longer than or equal to a predefined threshold time duration value.

13. The method of claim 3, wherein the one or more predetermined touch operations comprise a clicking operation having a predefined clicking position on the rear touch screen or having a predefined clicking position on the rear touch screen and a clicking time duration longer than or equal to a predefined threshold time duration value.

14. The method of claim 4, wherein the one or more predetermined touch operations comprise a clicking operation having a predefined clicking position on the rear touch screen or having a predefined clicking position on the rear touch screen and a clicking time duration longer than or equal to a predefined threshold time duration value.

15. A device for application switching, comprising:
a processor;
a memory for storing instructions executable by the processor;
a front display screen; and
a touch screen located separately from the front display screen on the device,
wherein the processor is configured to:
detect a user touch operation on the touch screen;
switch to a background a foreground application on a current display interface of the front display screen of the terminal; and
switch to the foreground an application selected from one or more opened background applications running on the device based on the detected user touch operation and a correspondence relationship between each of the one or more opened background applications and each of one or more predetermined touch operations on the touch screen.

16. The device of claim 15, wherein the processor is further configured to maintain an information log of the one or more opened background applications and wherein the correspondence relationship between each of the one or more opened background applications and each of the one or more predetermined touch operations is based at least on the information log.

17. The device of claim 15, wherein the one or more predetermined touch operations comprise a swiping operation having a predefined swiping direction or having a predefined swiping direction and swiping distance larger than or equal to a predefined threshold distance value.

18. The device of claim 17, wherein the processor is further configured to:
determine a swiping direction and a swiping distance according to a start position and an end position of the detected user touch operation on the rear screen of the terminal.

19. The device of claim 15, wherein the one or more predetermined touch operations comprise a clicking operation having a predefined clicking position on the rear touch screen or having a predefined clicking position on the rear touch screen and a clicking time duration longer than or equal to a predefined threshold time duration value.

20. A non-transitory computer-readable storage medium having instructions stored thereon, the instructions when executed by a processor of a terminal cause the terminal to:
detect a user touch operation on a touch screen of the terminal;
switch to a background a foreground application on a current display interface of a front display screen of the terminal; and
switch to the foreground an application selected from one or more opened background applications running on the terminal based on the detected user touch operation and a correspondence relationship between each of the one or more opened background applications and each of one or more predetermined touch operations on the touch screen of the terminal,
wherein the touch screen is located separately from the front display screen on the terminal.
